(19) United States
(12) Patent Application Publication
(10) Pub. No.: US 2026/0369119 A1
(43) Pub. Date: Nov. 19, 2026

(54) DISPENSING MACHINE

(71) Applicant: SANDENVENDO EUROPE S.P.A., Coniolo (IT)

(72) Inventors: Danilo SPAGNA, Coniolo (IT); Pierluigi CAMPAGNOLA, Coniolo (IT)

(73) Assignee: SANDENVENDO EUROPE S.P.A., Coniolo (IT)

(21) Appl. No.: 19/136,684

(22) PCT Filed: Oct. 30, 2023
(86) PCT No.: PCT/IT2023/050242

§ 371 Date: Jun. 6, 2025

(30) Foreign Application Priority Data
Dec. 19, 2022 (IT) 102022000025986

(51) Int. Cl. G07F 17/00; F25B 21/04; F25D 11/02

(52) U.S. Cl. CPC G07F 17/0064; F25B 21/04; F25D 11/02

(57) ABSTRACT

An improved dispensing machine (1) for food products is described, comprising: a containing 5 element or cabinet (3) equipped with at least one door or display case (5) for the products; a collection element (7) from which a user is able to collect the purchased products; at least one tray (11) contained in the refrigerated compartment of 10 the containment element (3), the tray (11) being designed to support food products; a user interface device operatively connected to the dispensing machine (1) to allow the user to select the products; a thermoelectric module (9) designed to 15 control the temperature inside the dispensing machine (1); a system of Peltier cells (13) and ventilated aluminium heat sinks operatively connected to the thermoelectric module (9); and a control logic designed to electrically control the 20 dispensing machine (1).

The present invention refers to an improved dispensing machine for food products, having small sizes and equipped with a thermoelectric module and a Peltier cooling system.

Documents GB-A-1 438 823 and JP-A-H 10 241032 describe dispensing machines according to the prior art.

Object of the present invention is therefore providing an improved dispensing machine for small-sized food products and equipped with a Peltier cooling system due to which it is possible to modify the internal temperature of the machine itself depending on the products contained inside it.

The above and other objects and advantages of the invention, as will appear from the following description, are achieved with an improved dispensing machine as claimed in claim 1. Preferred embodiments and non-trivial variations of the present invention form the subject matter of the dependent claims.

It is understood that all attached claims form an integral part of this description.

It will be immediately obvious that numerous variations and modifications can be made to what is described (for example relating to shape, dimensions, arrangements and parts with equivalent functionality) without departing from the scope of the invention as appears from the attached claims.

The present invention will be better described by some preferred embodiments, provided by way of a non-limiting example, with reference to the attached drawings, in which:

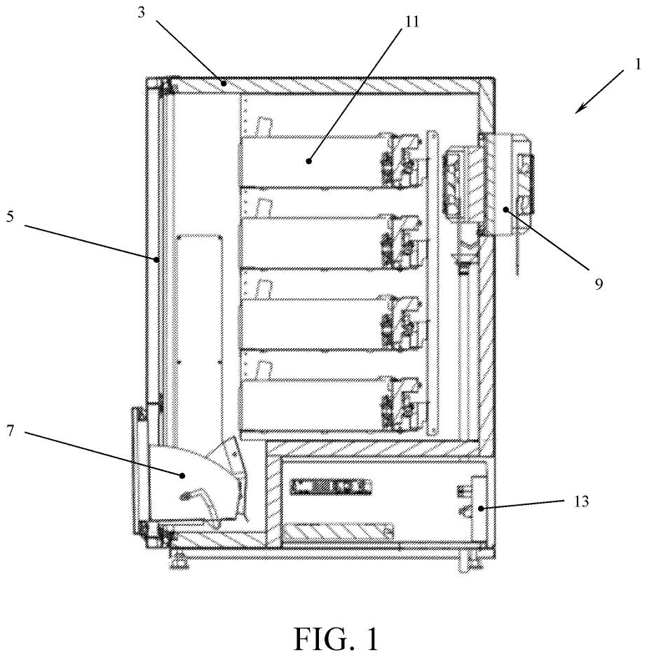

FIG. 1 shows a side view of a cross-section of an embodiment of the improved dispensing machine according to the present invention;

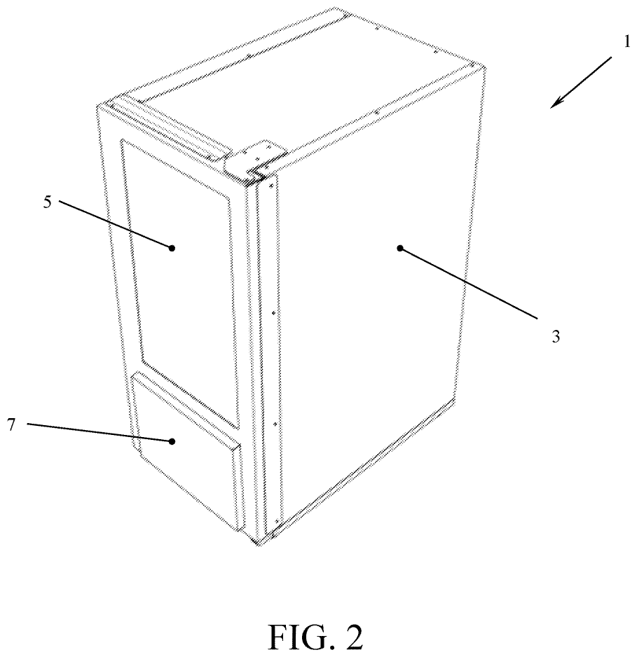

FIG. 2 shows a front perspective view of an embodiment of the improved dispensing machine according to the present invention;

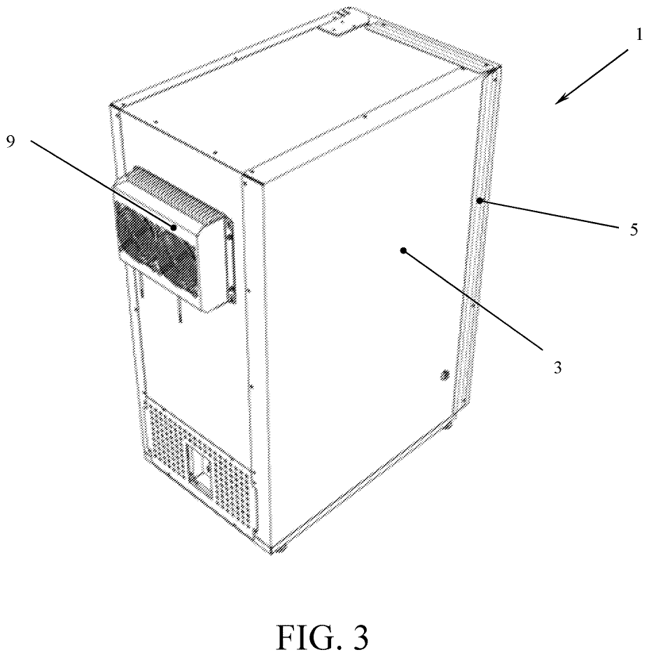

FIG. 3 shows a perspective view of the rear of an embodiment of the improved dispensing machine according to the present invention;

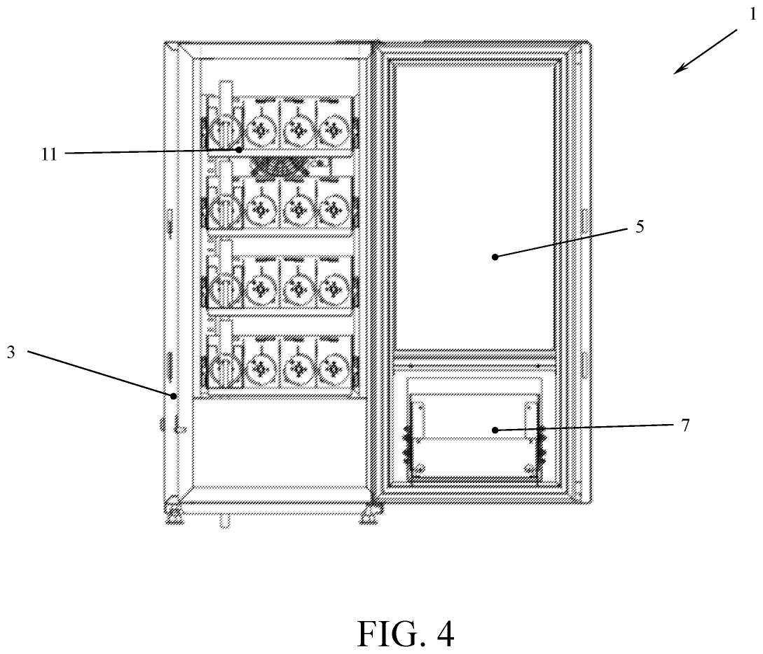

FIG. 4 shows a front view with the door in the open operating position of an embodiment of the improved dispensing machine according to the present invention.

Referring to the Figures, it is possible to note that the improved dispensing machine 1 of the invention, which is used for dispensing food products, substantially comprises:
at least one containment element 3 (commonly called “cabinet”) with a maximum height of 1 meter and a maximum depth of 600 mm, equipped with a refrigerated compartment with a maximum width of 400 mm, and equipped with at least one door or showcase 5 for inserting and viewing the products contained inside;
at least one product collection element 7 from which a user is able to collect the purchased products;
at least one tray 11 contained in the refrigerated compartment of the containment element 3, the tray 11 being designed to support the food products (not shown) contained inside the cabinet 3;
at least one user interface device (not shown) operatively connected to the dispensing machine 1 to allow the selection of products by the user.

The improved dispensing machine 1 object of the present invention is an air-conditioned cabinet of limited sizes (maximum height 1 meter, maximum width 600 mm and maximum width of the refrigerated compartment of 400 mm) capable of dispensing small-format products, typically sweet or savoury snacks.

Advantageously, the temperature inside the machine is controlled by means of a thermoelectric module 9 which works with a system of Peltier cells 13 and ventilated aluminium heat sinks (not shown).

The module 9 with the system of Peltier cells 13, in addition to allowing cooling, can be used, by reversing its polarity, as a heating system; therefore, the user can be offered the possibility of having a multipurpose machine that cools or heats the products inside depending on the type of food contained in the machine itself.

The control logic electrically controls the system in order to guarantee an internal temperature preset by the user, and the thermoelectric air conditioning allows temperatures to be set lower or higher than ambient temperature, thus making it possible to cool or heat the products inside.

Furthermore, the product selection user interface device can be present in standalone mode, or it can be remote in slave mode.

Advantageously, once the desired product has been selected, it is dispensed by the machine 1 and the user can collect it from the collection element 7 located at the bottom, on the front of the machine 1.

The product collection element 7 is integrated into the door 5, while the containment element 3 houses the trays 11 which support the various food products.

The thermoelectric module 9 is installed on the back of the improved dispensing machine 1 and in the lower rear part all the electrical systems to control the dispensing of the products and the module 9 with the system of Peltier cells 13 are located.

1. Dispensing machine (1) for food products comprising:
at least one container element or air-conditioned cabinet (3) with a maximum height of 1 meter and a maximum depth of 600 mm, equipped with a refrigerated compartment with a maximum width of 400 mm, and equipped with at least one door or display case (5) for products;
at least one collection element (7) from which a user is able to collect the purchased products;
at least one tray (11) contained in the refrigerated compartment of said containment element (3), said tray (11) being designed to support said food products;
at least one user interface device operatively connected to said dispensing machine (1) to allow the selection of products by the user;
at least one thermoelectric module (9) designed to control the temperature inside the dispensing machine (1);
at least one system with Peltier cells (13) operatively connected to said thermoelectric module (9), said system with Peltier cells (13) being used as a cooling system or, by reversing the polarity, as a heating system for the products contained in said dispensing machine (1);
ventilated aluminium heat sinks operatively connected to said thermoelectric module (9);
a control logic designed to electrically control the dispensing machine (1) in order to guarantee an internal temperature preset by the user, while thermoelectric air conditioning allows temperatures to be set lower or higher than the room temperature;
wherein the thermoelectric module (9) is installed on the back of the dispensing machine (1), while all electrical systems to control the dispensing of the products contained in the dispensing machine (1), and to control the system with Peltier cells (13), are located in the lower rear part of the dispensing machine (1).

2. Improved dispensing machine (1) according to claim 1, characterized in that said user interface device is present in standalone mode and/or remotely in slave mode.
